(19) United States
(12) Patent Application Publication
(10) Pub. No.: US 2026/0369552 A1
(43) Pub. Date: Nov. 19, 2026

(54) ELECTRODE FOR ALL-SOLID-STATE BATTERY AND ALL-SOLID-STATE BATTERY INCLUDING THE SAME

(71) Applicant: ELECTRONICS AND TELECOMMUNICATIONS RESEARCH INSTITUTE, Daejeon (KR)

(72) Inventors: Ju Young KIM, Daejeon (KR); Yunho LEE, Daejeon (KR); Young-Gi LEE, Daejeon (KR); Jaecheol CHOI, Daejeon (KR); Seok Hun KANG, Daejeon (KR)

(21) Appl. No.: 19/421,217

(22) Filed: Dec. 16, 2025

(30) Foreign Application Priority Data
Mar. 25, 2025 (KR) 10-2025-0038088
Jul. 24, 2025 (KR) 10-2025-0100567

(51) Int. Cl. H01M 4/36; H01M 4/02; H01M 4/505; H01M 4/525; H01M 4/58; H01M 4/583; H01M 4/62; H01M 10/0562

(52) U.S. Cl. CPC H01M 4/364; H01M 4/505; H01M 4/525; H01M 4/5825; H01M 4/583; H01M 4/625; H01M 10/0562; H01M 2004/021; H01M 2300/008

(57) ABSTRACT

Provided is an electrode for an all-solid-state battery, including a current collector, and an active material layer on the current collector, wherein the active material layer includes active material particles, solid electrolyte particles mixed with the active material particles, and a conductive material applied onto the active material particles. The conductive material has a diameter of about 1 to about 500 nm, the conductive material has a length of about 1 to about 500 μm, and the conductive material has an aspect ratio of about 5 to about 50,000. The conductive material is present in an amount of about 0.01 to about 0.5 parts by weight with respect to 100 parts by weight of the active material particles.

### CROSS-REFERENCE TO RELATED APPLICATIONS

This U.S. non-provisional patent application claims priority under 35 U.S.C. § 119 of Korean Patent Application Nos. 10-2025-0038088, filed on Mar. 25, 2025, and 10-2025-0100567, filed on Jul. 24, 2025, the entire contents of which are hereby incorporated by reference.

### BACKGROUND

### 1. Field of the Invention

The present disclosure herein relates to an electrode for an all-solid-state battery and an all-solid-state battery including the same.

### 2. Description of Related Art

Lithium ion secondary batteries are utilized in various fields, including portable electronic devices, electric vehicles (EVs), and energy storage systems (ESS). Typical secondary batteries use liquid electrolytes as an electrolyte, and the liquid electrolytes provide benefits such as high ionic conductivity and excellent charge/discharge characteristics. However, the liquid electrolytes are sensitive to external factors such as external shock, high-temperature, or low-temperature environments, which may lead to safety issues such as ignition and explosion.

To overcome these issues, all-solid-state batteries utilizing solid electrolytes are being actively studied. The all-solid-state batteries use solid electrolytes as an electrolyte, and may thus provide high electrical stability. However, the solid electrolytes, compared to liquid electrolytes, have limitations that lead to degraded battery performance due to issues such as low ionic conductivity, increased electrode-electrolyte interfacial resistance, and insufficient electron and ion conduction pathways within an electrode.

To overcome this performance degradation, composite electrode design is being adopted, and in particular, it is important to improve the output characteristics and charge/discharge efficiency of all-solid-state batteries by optimizing the arrangement of conductive materials and solid electrolytes.

### SUMMARY

The present disclosure provides an electrode for an all-solid-state battery capable of achieving high power by improving the spatial arrangement of a conductive material and a solid electrolyte within the electrode, and an all-solid-state battery including the same.

The present disclosure also provides an all-solid-state secondary battery capable of further increasing energy density compared to typical electrodes through efficient selection and arrangement of a conductive material.

The present disclosure also provides a high-loading electrode for an all-solid-state battery and an all-solid-state battery including the same through an electrode for an all-solid-state battery having excellent electronic and ionic conductivities.

The present disclosure also provides an electrode for an all-solid-state battery having excellent electronic and ionic conductivities and an all-solid-state battery including the same.

Meanwhile, the purposes of the present disclosure are not limited to the above-mentioned purposes, and other purposes not mentioned would be clearly understood by those skilled in the art from the disclosure below.

An embodiment of the inventive concept provides an electrode for an all-solid-state battery, including a current collector, and an active material layer on the current collector, wherein the active material layer includes active material particles, solid electrolyte particles mixed with the active material particles, and a conductive material applied onto the active material particles, wherein the conductive material has a diameter of about 1 to about 500 nm, the conductive material has a length of about 1 to about 500 μm, the conductive material has an aspect ratio of about 5 to about 50,000, and the conductive material is present in an amount of about 0.01 to about 0.5 parts by weight with respect to 100 parts by weight of the active material particles.

In some embodiment, the conductive material may include single-walled carbon nanotubes or multi-walled carbon nanotubes.

In some embodiment, the active material particles may include at least one of LiNiₓCo_{y}Mn_{z}O₂ (x+y+z=1), LiMn₂O₄, or LiFePO₄.

In some embodiment, the active material particles may include at least one of natural graphite, artificial graphite, amorphous carbon, silicon, silicon-carbon (Si—C), silicon oxide (SiOₓ), aluminum, tin, or Li₄Ti₅O₁₂ (LTO).

In some embodiment, the solid electrolyte particles may include at least one of Li₄₋ₓGe₁₋ₓPₓS₄ (LGPS), Li₃PS₄ glass-ceramic, Li₇P₃S₁₁ glass-ceramic (LPS), Li₄SnS₄, Li₆PS₅X (X=Cl, Br, I), Li₃ErX₆, Li₃GdX₆, Li₃YX₆, or Li₃InX₆ (X =Cl, Br, I).

In some embodiment, the conductive material may be present in an amount of about 0.05 to about 0.2 parts by weight with respect to 100 parts by weight of the active material particles.

In some embodiment, the electrode for an all-solid-state battery may further include a positive electrode protection layer in the active material layer, wherein the positive electrode protection layer may be applied onto the active material particles coated with the conductive material, and the positive electrode protection layer may include at least one of lithium niobate (LiNbO₃), lithium tantalate (LiTaO₃), lithium aluminum oxide (LiAlO₂), or lithium phosphate (Li₃PO₄).

In some embodiment, the active material particles in the electrode for an all-solid-state battery may have a volume fraction of about 0.5 to about 0.99.

In an embodiment of the inventive concept, an all-solid-state battery includes a first electrode, a second electrode spaced apart from the first electrode, and a solid electrolyte layer interposed between the first electrode and the second electrode, wherein at least one of the first electrode or the second electrode includes a current collector, and an active material layer on the current collector, the active material layer includes active material particles, solid electrolyte particles mixed with the active material particles, and a one-dimensional conductive material applied onto the active material particles, and the conductive material is present in an amount of about 0.01 to about 0.5 parts by weight with respect to 100 parts by weight of the active material particles.

In some embodiment, the one-dimensional conductive material may include single-walled carbon nanotubes or multi-walled carbon nanotubes.

In some embodiment, the active material particles may have a size of about 300 nm to about 100 μm.

In some embodiment, the conductive material may be present in an amount of about 0.05 to about 0.2 parts by weight with respect to 100 parts by weight of the active material particles.

In some embodiment, the solid electrolyte particles of the first electrode or the second electrode may have a volume fraction of about 0.01 to about 0.5.

In some embodiment, the active material layer of the all-solid-state battery may further include a binder.

In an embodiment of the inventive concept, an all-solid-state battery includes a positive electrode, a negative electrode spaced apart from the positive electrode, and a solid electrolyte layer interposed between the positive electrode and the negative electrode, wherein the positive electrode includes a positive electrode current collector, and a positive electrode active material layer on the positive electrode current collector, and the positive electrode active material layer includes a first portion and a second portion, wherein in the first portion, solid electrolyte particles are disposed, and in the second portion, positive electrode active material particles and a conductive material are disposed.

In some embodiment, the positive electrode may have an areal capacity of about 3 to about 15 mAh/cm².

In some embodiment, the conductive material may include single-walled carbon nanotubes or multi-walled carbon nanotubes.

In some embodiment, the positive electrode may have a tortuosity of about 1.5 to about 8.

In some embodiment, the conductive material may not be positioned in the first portion.

In some embodiment, the conductive material may be present in an amount of about 0.01 to about 0.5 parts by weight with respect to 100 parts by weight of the positive electrode active material particles.

### BRIEF DESCRIPTION OF THE DRAWINGS

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a cross-sectional view showing an all-solid-state battery according to an embodiment of the inventive concept;

FIG. 2 is a cross-sectional view enlarging region M of FIG. 1;

FIG. 3 is a cross-sectional view enlarging region M′ of FIG. 2;

FIGS. 4A and 4B show SEM analysis results for active material particles according to Example 1 of the inventive concept;

FIGS. 5A and 5B show SEM analysis results for active material particles according to Example 2 of the inventive concept;

FIGS. 6A and 6B show SEM analysis results for active material particles according to Example 3 of the inventive concept;

FIG. 7 shows SEM analysis results for an electrode for an all-solid-state battery according to Example 1 of the inventive concept;

FIG. 8 shows SEM analysis results for an electrode for an all-solid-state battery according to Comparative Example 1 of the inventive concept;

FIG. 9 shows electronic conductivity EIS measurement results for electrodes for an all-solid-state battery according to Example 1, Example 2, Example 3, and Comparative Example 1 of the inventive concept;

FIG. 10 shows ionic conductivity EIS measurement results for electrodes according to Example 1, Example 2, Example 3, and Comparative Example 1 of the inventive concept;

FIG. 11 shows electronic conductivity and ionic conductivity analysis results for electrodes according to Example 1, Example 2, Example 3, and Comparative Example 1 of the inventive concept;

FIG. 12 shows tortuosity analysis results for ionic conductivity of electrodes according to Example 1, Example 2, Example 3, and Comparative Example 1 of the inventive concept;

FIG. 13 shows charge/discharge characteristic analysis results for electrodes according to Example 1, Example 2, Example 3, and Comparative Example 1 of the inventive concept;

FIG. 14 shows capacity retention comparison results for electrodes according to Example 1, Example 2, Example 3, and Comparative Example 1 of the inventive concept;

FIGS. 15A and 15B show GITT analysis results for electrodes according to Example 1 and Comparative Example 1 of the inventive concept;

FIG. 16 shows rate evaluation results for electrodes according to Example 1 and Comparative Example 1 of the inventive concept;

FIG. 17 shows achieved capacity evaluation results according to the loading amount of electrodes according to Example 4 and Comparative Example 2 of the inventive concept;

FIG. 18 shows energy density per unit volume evaluation results according to the loading amount of electrodes according to Example 4 and Comparative Example 2 of the inventive concept;

FIG. 19 shows electrode thickness evaluation results according to the loading amount of electrodes according to Example 4 and Comparative Example 2 of the inventive concept; and

FIG. 20 is capacity retention analysis results for an electrode according to Example 5 of the inventive concept.

### DETAILED DESCRIPTION

In order to facilitate sufficient understanding of the configuration and effects of this disclosure, preferred embodiments of the disclosure will be described with reference to the accompanying drawings. However, the present disclosure may be embodied in different forms with various changes, but not limited to the embodiments set forth herein. Rather, these embodiments are provided so that this disclosure will be thorough and complete, and will fully convey the scope of the present disclosure to a person skilled in the art to which the invention pertains.

As used herein, it will be understood that when a component is referred to as being on another component, it may be directly on another component, or an intervening third component may also be present. Also, in the drawings, the thicknesses of the components are exaggerated for effectively describing the technical features. Like reference numerals refer to like elements throughout.

The embodiments described in this description will be explained with reference to the cross-sectional views and/or plan views as ideal example views of the present disclosure. In the drawing, the thicknesses of films and regions are exaggerated for effective description of the technical contents. Thus, regions presented as an example in the drawings have general properties, and shapes of the exemplified areas are used to illustrate a specific shape of a device region. Therefore, this should not be construed as limited to the scope of the present disclosure. Although the terms such as first, second, and third are used to describe various components in various embodiments of this specification, the components should not be limited to these terms. These terms are used only to distinguish one component from another component. Embodiments described and exemplified herein include complementary embodiments thereof.

As used herein, the terms are used only for explaining embodiments while not limiting the present disclosure. As used herein, singular forms include plural forms as well, unless the context clearly indicates otherwise. The meaning of “comprises” and/or “comprising” used herein does not exclude the presence or addition of one or more other components besides a mentioned component.

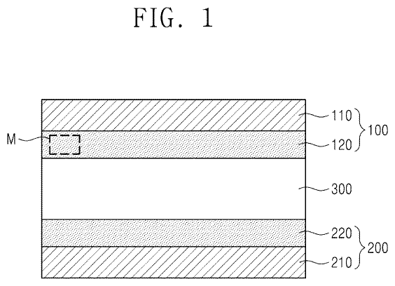

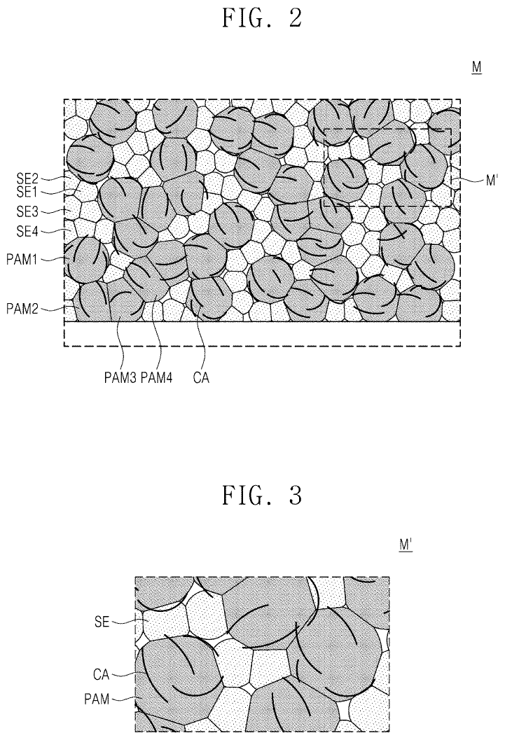

FIG. 1 is a cross-sectional view showing an all-solid-state battery according to an embodiment of the inventive concept. FIG. 2 is a cross-sectional view enlarging region M of FIG. 1. FIG. 3 is a cross-sectional view enlarging region M′ of FIG. 2.

Referring to FIG. 1, an all-solid-state battery 10 according to an embodiment may include a positive electrode 100, a negative electrode 200 facing the positive electrode, and a solid electrolyte layer 300 interposed between the positive electrode 100 and the negative electrode 200.

The positive electrode 100 may include a positive electrode current collector 110 and a positive electrode active material layer 120 disposed on the positive electrode current collector 110. The positive electrode current collector 110 may provide a reference surface on which the positive electrode active material layer 120 is disposed. The positive electrode current collector 110 may include a metal that exhibits excellent electrical conductivity and may maintain chemical stability during an electrochemical reaction at the positive electrode 100. For example, the positive electrode current collector 110 may include a plate or a foil containing indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

The negative electrode 200 may include a negative electrode current collector 210 and a negative electrode active material layer 220 on the negative electrode current collector 210. The negative electrode current collector 210 may provide a reference surface on which the negative electrode active material layer 220 is disposed. The negative electrode current collector 210 may include a metal that does not react with lithium, exhibits excellent electrical conductivity, and may maintain chemical stability during an electrochemical reaction. For example, the negative electrode current collector 210 may include at least one metal selected from the group consisting of copper (Cu), stainless steel, titanium (Ti), iron (Fe), cobalt (Co), and nickel (Ni).

Referring to FIGS. 2 and 3, the positive electrode active material layer 120 may include positive electrode active material particles PAM, solid electrolyte particles SE, and a conductive material CA.

A region where solid electrolyte particles SE1, SE2, SE3, and SE4 are disposed may be defined as a “first portion”, and a region where the positive electrode active material particles PAM1, PAM2, PAM3, and PAM4 and the conductive material CA are disposed may be defined as a “second portion”.

The positive electrode active material particles PAM and the solid electrolyte particles SE may be disposed in a mixed state within the positive electrode active material layer 120. The conductive material CA may be applied onto a surface of the positive electrode active material particles PAM. The positive electrode active material layer 120 is formed in a structure in which the conductive material CA is applied onto the surface of the positive electrode active material particles PAM, and thus, the conductive material CA is selectively positioned on the surface of the positive electrode active material particles PAM, separate from the solid electrolyte particles SE, thereby forming an independent electron conduction pathway without interfering with an ion transfer pathway within the solid electrolyte particles SE. This may improve both the electronic and ionic conductivities of the positive electrode active material layer 120, and excellent performance may be exhibited in reducing the tortuosity of the ionic conductivity, achieving high energy density and high power, and ensuring performance stability in a high-loading electrode.

The positive electrode active material particles PAM may serve to store and release electrochemical energy by performing a redox reaction according to the intercalation and deintercalation of lithium ions. For example, the positive electrode active material particles PAM may include a positive electrode active material such as LiNiₓCo_{y}Mn_{z}O₂ (x+y+z=1), LiMn₂O₄, and LiFePO₄, or sulfur (S). The positive electrode active material particles PAM may be formed to have a particle size ranging from about 500 nanometers (nm) to about 50 micrometers (μm). According to some embodiments, the positive electrode active material particles PAM in the positive electrode 100 may be included in a ratio of about 0.5 to about 0.99 with respect to a total volume of the positive electrode 100. More preferably, the positive electrode active material particles PAM may be included in a ratio of about 0.7 to about 0.99.

The conductive material CA may be applied onto the surface of the active material particles PAM. The conductive material CA is applied onto the surface of the active material particles PAM, and may enable an electron conduction pathway and a lithium ion conduction pathway within the positive electrode 100 to be independently formed. The conductive material CA may be present in an amount of about 0.01 to about 0.5 parts by weight, preferably about 0.05 to about 0.2 parts by weight, with respect to 100 parts by weight of the positive electrode active material particles PAM.

As the conductive material CA, a zero-dimensional conductive material, a one-dimensional conductive material, or a two-dimensional conductive material may be used, and preferably, a one-dimensional conductive material may be used. The one-dimensional conductive material, even in small amounts, may form a percolation conduction pathway, and the one-dimensional conductive material, having linear structural characteristics, may not interfere with a lithium ion transfer pathway. The one-dimensional conductive material may have strong physical bonding with the positive electrode active material particles PAM. As the one-dimensional conductive material, single-walled carbon nanotubes (SWCNT) or multi-walled carbon nanotubes (MWCNT) may be used. The conductive material CA may be formed to have an average diameter of about 1 to about 500 nanometers (nm), an average length of about 1 to about 500 micrometers (μm), and an aspect ratio of about 50 to about 50,000.

The solid electrolyte particles SE may serve to transfer lithium ions in the space between the positive electrode active material particles PAM. A sulfide-based solid electrolyte and a halide-based solid electrolyte may be used as the solid electrolyte particles SE. For example, the sulfide-based solid electrolyte may include Li₄₋ₓGe₁₋ₓPₓS₄ (LGPS), Li₃PS₄ glass-ceramic, Li₇P₃S₁₁ glass-ceramic (LPS), Li₄SnS₄, and Li₆PS₅X (X=Cl, Br, I), and the halide-based solid electrolyte may include Li₃ErX₆, Li₃GdX₆, Li₃YX₆, and Li₃InX₆ (X=Cl, Br, I).

The solid electrolyte particles SE may be formed to have an average particle size ranging from about 500 nanometers (nm) to about 5 micrometers (μm), preferably ranging from about 500 nanometers (nm) to about 3 micrometers (μm).

According to some embodiments of the inventive concept, the conductive material CA may first be applied onto the surface of the positive electrode active material particles PAM, and then a positive electrode protection layer may be additionally formed. The positive electrode protection layer may include at least one of lithium niobate (LiNbO₃), lithium tantalate (LiTaO₃), lithium aluminum oxide (LiAlO₂), or lithium phosphate (Li₃PO₄). The positive electrode protection layer is a layer additionally applied onto the surface of the conductive material CA formed on the surface of the positive electrode active material particles PAM, and may serve to block direct contact between the positive electrode active material particles PAM and the solid electrolyte particles SE.

According to some embodiments of the inventive concept, the positive electrode active material layer 120 may further include a binder.

The binder may serve to enhance interfacial adhesion between the positive electrode active material particles PAM and the solid electrolyte particles SE, thereby ensuring the mechanical stability of the positive electrode 100. The binder may include at least one of styrene-butadiene rubber (SBR), nitrile rubber (NBR), ethylene propylene diene monomer (EPDM), silicone rubber, butadiene rubber, polyurethane rubber, polyethylene, polypropylene, polystyrene, polybutadiene, polychloroprene, or polymethyl methacrylate (PMMA).

Hereinafter, a method for manufacturing a positive electrode active material layer 120 according to the inventive concept will be described in detail.

The process for manufacturing the positive electrode active material layer 120 according to the inventive concept may include a process of applying a conductive material CA onto a surface of positive electrode active material particles PAM, and a process of mixing the positive electrode active material particles PAM coated with the conductive material CA with a solid electrolyte.

The process of applying the conductive material CA onto the surface of the positive electrode active material particles PAM may include performing a liquid dispersion process of the conductive material CA, mixing the liquid-dispersed conductive material CA slurry and the positive electrode active material particles PAM to prepare positive electrode active material particles PAM coated with the conductive material CA, drying the positive electrode active material particles PAM coated with the conductive material CA to remove a solvent, and heat-treating the dried positive electrode active material particles PAM coated with the conductive material CA.

The liquid dispersion process of the conductive material CA may include dispersing the conductive material CA in a solvent to prepare a slurry. A surfactant or a polymer may also be used in the dispersion process of the conductive material CA. The surfactant or the polymer may be adsorbed onto the surface of the conductive material CA particles to form a structure that prevents aggregation and enhances dispersion stability. This allows the conductive material CA particles to remain uniformly dispersed within the solvent, thereby enabling stable dispersion.

For example, the surfactant may include at least one of alkyl sulfates, alkyl ether sulfates, alkyl benzene sulfonates, alpha-olefin sulfonates, alkyl phosphate esters, ester-type quaternary ammonium, pyridinium series, betaine series, imidazoline series, or sorbitan esters. The polymer may include at least one of polytetrafluoroethylene (PTFE), polyvinylidene fluoride (PVDF), polyethylene oxide (PEO), polyacrylonitrile (PAN), hydropropyl cellulose (HPC), carboxymethyl cellulose (CMC), styrene-butadiene (SBR), nitrile-butadiene (NBR), polyacrylate, or polyacrylic acid (PAA), and the polymer may have a molecular weight of about 100 to about 100,000,000 g/mol.

In the conductive material CA slurry, the conductive material CA may be included in an amount of about 0.01 to about 10 parts by weight with respect to 100 parts by weight of the slurry. The conductive material CA slurry may have a viscosity of about 100 cP to about 100,000 cP. Within the above viscosity range, the slurry may exhibit appropriate coating properties during the coating process, and accordingly, the conductive material CA may be uniformly applied onto the surface of the positive electrode active material particles PAM. This may enable the formation of a stable conduction pathway within an electrode.

When the conductive material CA slurry and the positive electrode active material particles PAM are mixed, the conductive material CA may be applied onto the surface of the positive electrode active material particles PAM. The mixing process may be performed through stirring, and may be controlled such that the conductive material CA is uniformly applied onto the surface of the positive electrode active material particles PAM.

A process of evaporating a solvent from the mixed slurry of the conductive material CA and the positive electrode active material particles PAM may include a stirring process. Specifically, the solvent may be evaporated while stirring the slurry at a temperature range of about 70 °C to about ½ to about ⅞ of the boiling point of the solvent. This process allows the conductive material CA to be uniformly applied onto the surface of the positive electrode active material particles PAM. After the solvent evaporation, a physical crushing process, such as a 50 μm sieving process, may be included, which may prevent particle aggregation and ensure a uniform particle size distribution.

The positive electrode active material particles PAM coated with the conductive material CA may be heat-treated at a temperature range of about 150 °C to about 500 °C. This process may remove residual solvent and improve the bonding strength of the coating layer.

The process of mixing the positive electrode active material particles PAM coated with the conductive material CA with the solid electrolyte may include mixing the solid electrolyte particles with the positive electrode active material particles PAM coated with the conductive material CA at a weight ratio of about 9.5 to about 49.5.

The mixing of the solid electrolyte and the positive electrode active material particles PAM coated with the conductive material CA may be performed using a dry mixing method or a wet mixing method. This mixing method may be selected based on the interfacial stability and particle dispersibility between the solid electrolyte and the active material particles coated with the conductive material, thereby ensuring the particle size distribution and uniformity of an electrode.

In the wet mixing method, a binder may be further included when mixing the solid electrolyte particles SE and the positive electrode active material particles PAM coated with the conductive material CA. The binder, depending on the solubility thereof, may be dissolved in a non-polar organic solvent and then mixed. For example, when the binder is non-polar, solvents such as anisole, xylene, toluene, alkyl acetate, and alkyl butyrate may be used, and the solvent may be appropriately selected based on the type of binder and the chemical properties of the solid electrolyte.

The mixed slurry including the binder solution may have specific solid particle content and viscosity characteristics. Solid particles including the positive electrode active material particles PAM, the solid electrolyte particles SE, and the conductive material CA may be included in an amount of about 20 to about 80 parts by weight with respect to 100 parts by weight of the mixed slurry. The viscosity of the slurry may be controlled within a range of about 100 cP to about 100,000 cP.

In the dry mixing method, the solid electrolyte particles SE and the positive electrode active material particles PAM coated with the conductive material CA may be directly mixed without using a solvent. Mixing equipment such as a dry blender, a turbo mixer, or mechanical milling may be used, and process conditions such as mixing speed, time, and mixing ratio may be optimized to improve particle dispersibility and interfacial properties.

The mixed powder or slurry may be applied onto the positive electrode current collector 110 to form the positive electrode active material layer 120. In the wet mixing process, the material may be applied using methods such as doctor blade, slot die, or curtain coating, and a coating thickness may be adjusted according to target electrode capacity and density. In the dry mixing process, the mixed powder may be stacked onto a current collector and then compression-molded to form an active material layer, and in this case, uniaxial pressing or triaxial pressing may be applied.

The coating process may further include a drying process and a heat treatment process. The drying process may include hot air drying or vacuum drying, and the heat treatment process may be additionally performed after the drying process. The heat treatment process may be performed at a temperature range of about 150 °C to about 500 °C. The heat treatment process may improve the bonding strength of an electrode and remove residual solvent.

Although not illustrated in FIG. 1, the negative electrode active material layer 220 may include negative electrode active material particles NAM, solid electrolyte particles SE mixed with the negative electrode active material particles NAM, and a conductive material CA applied onto the negative electrode active material particles NAM.

The negative electrode active material particles NAM may serve to perform an electrochemical reaction during the intercalation and deintercalation of lithium ions. Specifically, the negative electrode active material particles NAM may include at least one selected from the group consisting of natural graphite, artificial graphite, amorphous carbon, silicon (Si), silicon-carbon (Si—C) composites, silicon oxide (SiOₓ), aluminum (Al), tin (Sn), and lithium titanate oxide (Li₄Ti₅O₁₂; LTO). The negative electrode active material particles NAM may have an average particle size ranging from about 500 nanometers (nm) to about 50 micrometers (μm).

The solid electrolyte particles SE may serve to transfer lithium ions in the space between the negative electrode active material particles NAM, and sulfide-based and halide-based solid electrolytes may be applied.

The conductive material CA may be applied onto a surface of the negative electrode active material particles NAM, and may enable an electron conduction pathway and a lithium ion conduction pathway to be independently formed. As the conductive material CA, a zero-dimensional conductive material, a one-dimensional conductive material, or a two-dimensional conductive material may be used, and in particular, as a one-dimensional conductive material, single-walled carbon nanotubes SWCN or multi-walled carbon nanotubes MWCNT may be used.

The negative electrode active material layer 220 of the inventive concept is formed in a structure in which the conductive material CA is uniformly applied onto the surface of the negative electrode active material particles NAM, and accordingly, the conductive material CA may provide an independent electron conduction pathway without penetrating into a region of the solid electrolyte particles SE. Accordingly, the negative electrode active material layer 220 may exhibit both improved electronic and ionic conductivities, and may exhibit excellent performance in achieving high output and high energy density.

Although not illustrated in FIGS. 2 and 3, according to some embodiments of the inventive concept, the negative electrode active material layer 220 may further include a binder. The binder may include at least one selected from the group consisting of styrene-butadiene rubber (SBR), carboxymethyl cellulose (CMC), nitrile rubber, polyacrylic acid (PAA), and polyacrylate. The binder may be dissolved in a low-polar solvent, and for example, anisole, xylene, toluene, alkyl acetate, alkyl butyrate, and the like may be used. This may contribute to improving adhesion between the negative electrode active material particles NAM and the solid electrolyte particles SE and securing the mechanical strength of an electrode.

The process of preparing the negative electrode active material layer 220 may be performed in the same manner as the process of preparing the positive active material layer 120. More specifically, the process may include a process of applying the conductive material CA onto a surface of the negative electrode active material particles NAM, a process of mixing the negative electrode active material particles NAM coated with the conductive material CA with the solid electrolyte particles SE, a process of applying and molding the mixture onto the negative electrode current collector 210, and a process of drying and heat-treating the applied structure. The coating method, mixing ratio, and heat treatment conditions of the conductive material CA, like the characteristics of the positive electrode active material particles PAM and the solid electrolyte particles SE, may be equally applied or optimized according to the characteristics of the negative electrode active material particles NAM and the solid electrolyte particles SE. The electrodes 100 and 200 of the inventive concept, designed as described above, may exhibit excellent performance in high-power, high-energy-density, and high-loading electrodes due to improved electronic and ionic conductivities.

Based on to the design of electrodes 100 and 200 according to an embodiment of the inventive concept, with respect to 100 parts by weight of the electrodes 100 and 200, the active material particles PAM and NAM may be included in an amount of about 50 parts by weight to about 90 parts by weight, the binder may be included in an amount of about 0.5 parts by weight to about 5 parts by weight, and the solid electrolyte particles SE may be included in an amount of about 9.5 parts by weight to 49.5 parts by weight, and these amounts may be appropriately adjusted according to the design objective.

Based on the design of the electrodes 100 and 200, the active material layers 120 and 220 in the electrodes 100 and 200 are formed in a structure in which the conductive material CA is selectively applied onto the surface of the active material particles PAM and NAM, and a conduction pathway may be formed without electrochemical interference with the solid electrolyte particles SE.

Tortuosity, which quantitatively represents ion conduction efficiency, may be defined as follows:

Tortuosity=(volume of solid electrolyte×ionic conductivity of solid electrolyte)/(ionic conductivity within electrode)

This electrode design eliminates a charge transfer interference phenomenon that may occur in typical randomly mixed electrodes and maintains the tortuosity within the electrodes 100 and 200 in the range of about 1.5 to about 8, preferably about 1.5 to about 6, and may thus effectively improve ion conduction properties. In addition, the surface coating method of the conductive material CA may improve packing density, contributing to preparation of high-density electrodes and achieving high energy densities.

In addition, the electrodes 100 and 200 are formed in a structure in which the conductive material CA is selectively applied onto the surface of the active material particles PAM and NAM, thereby efficiently separating and optimizing the electron and ion conduction pathways within the electrodes. Based on this electrode design, the electrodes 100 and 200 of the inventive concept may maintain excellent charge transfer characteristics even under high-loading conditions, and may achieve a high capacity of about 3 to about 15 mAh/cm² per area. In particular, the design may secure discharge performance close to theoretical capacity, thereby providing an electrode structure suitable for achieving high-energy-density batteries and high-power batteries.

Hereinafter, the present disclosure will be described in more detail with reference to Examples. However, these Examples are presented only for describing the present disclosure as an example, and the scope of the present disclosure is not limited thereto.

### Example 1

LiCoO₂ was prepared as an active material. As a one-dimensional conductive material, a carbon nanotube solution pre-dispersed in water via carboxymethyl cellulose was used. A mixing ratio of the active material and the conductive material was set to 100:0.1 by weight, and water was evaporated with stirring at 70 °C. After water was completely evaporated, the aggregated particles were crushed using a mortar and pestle, and a sample having a uniform particle size distribution was obtained through 50 μm sieving. Li₃InCl₆ was prepared and used as a solid electrolyte. Indium chloride (InCl₃) and lithium chloride (LiCl) were mixed in a molar ratio, and then heat-treated at 260 °C for 5 hours to prepare Li₃InCl₆. Before mixing, the sample was milled with zirconia balls at 500 rpm for 18 hours. The prepared sample had an ionic conductivity of 0.53 mS/cm. The active material coated with the conductive material and the solid electrolyte were mixed at a weight ratio of 70:30 to form an electrode. Electrode performance was evaluated in a half-cell using lithium metal as a counter electrode, with a Li₆PS₅Cl solid electrolyte membrane applied between a positive electrode and a negative electrode. Capacity per electrode area was set to 3 mAh/cm², evaluation temperature was set to 27 °C, and voltage cutoff was set from 3.0 V to 4.2 V. Electronic conductivity was measured using EIS analysis on electrodes prepared from mixed powders, and ionic conductivity was measured using symmetrical cell and TLM analysis.

### Example 2

An active material and a conductive material were prepared under the same conditions as in Example 1, except that the mixing ratio was set to 100:0.2 by weight. Subsequently, processes and analyses were conducted in the same manner as in Example 1.

### Example 3

An active material and a conductive material were prepared under the same conditions as in Example 1, except that the mixing ratio was set to 100:0.3 by weight. Subsequently, processes and analyses were conducted in the same manner as in Example 1.

### Example 4

Using the electrode of Example 1, achieved capacity and electrode thickness were evaluated by changing the loading amount to 51, 71, 102, 132, and 153 mg/cm².

### Example 5

To design a high-energy-density and high-power electrode, LiNi_{0.6}Co_{0.2}Mn_{0.2}O₂ (NCM622) active material having a specific capacity of about 170 mAh/g and LPSCl solid electrolyte having an ionic conductivity of about 1 mS/cm were used. As in Example 1, a coating process was performed using carbon nanotubes (CNT) at a ratio of 100:0.1 with respect to weight of the active material.

However, to address oxidation stability issues associated with the use of sulfide-based solid electrolytes, a LiNbO₃ protection layer was additionally subjected to wet-coating onto a surface of the NCM622 active material coated with the conductive material. The protection layer coating process was performed using a solution in which a LiNbO₃ precursor was dissolved, and heat treatment was performed at 600 °C for 5 hours after coating to form the protection layer.

Subsequently, electrode evaluation was conducted using the same method as in Examples above. The solid content ratio was set identically, and electrodes were prepared with a theoretical capacity per unit area of about 3.6 mAh/cm². Charge/discharge evaluation was performed three times at a 0.1 C-rate, and subsequently (or thereafter) at a 0.2 C-rate.

### Comparative Example 1

To determine the coating effect of the conductive material, electrodes were prepared by randomly mixing an active material, a solid electrolyte, and a conductive material. LiCoO2 with no surface coating was used as the active material, Li₃InCl₆ was used as the solid electrolyte, and zero-dimensional carbon black was used as the conductive material. The mixing ratio was set to 68:30:2 (active material: solid electrolyte: conductive material) by weight. The process and analysis were performed in the same manner as in Example 1.

### Comparative Example 2

Using the electrode of Comparative Example 1, achieved capacity and electrode thickness were evaluated by changing the loading amount to 51, 71, 102, 132, and 153 mg/cm².

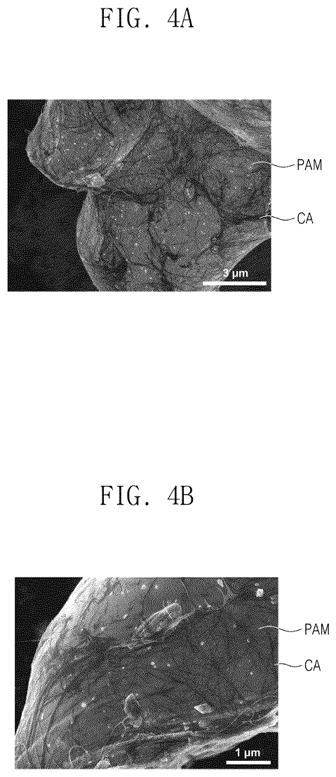

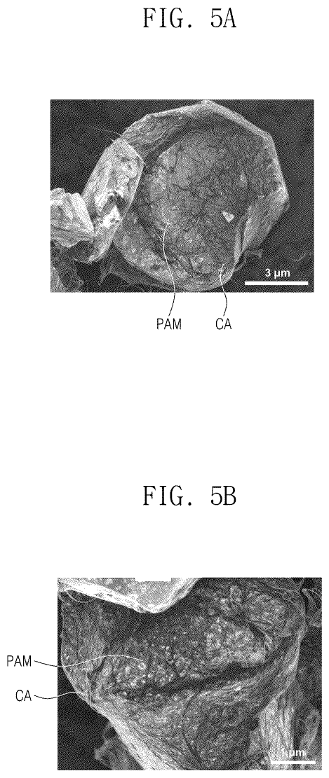

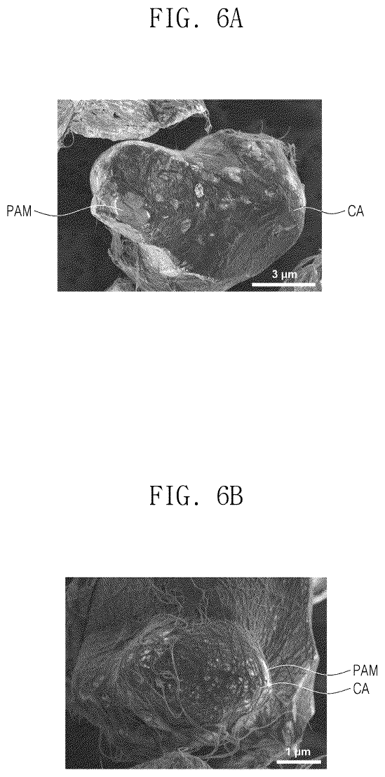

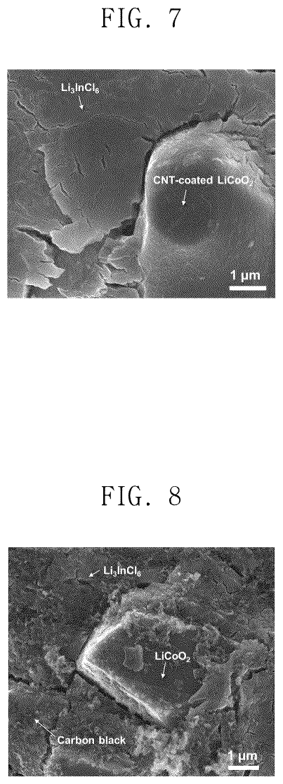

FIGS. 4A and 4B show SEM analysis results for active material particles according to Example 1 of the inventive concept. FIGS. 5A and 5B show SEM analysis results for active material particles according to Example 2 of the inventive concept. FIGS. 6A and 6B show SEM analysis results for active material particles according to Example 3 of the inventive concept.

Referring to FIGS. 4A and 4B, a structure in which a thin, linear conductive material CA (carbon nanotubes, CNT) is thinly and uniformly applied along the surface of the positive electrode active material particles PAM (LiCoO₂) according to Example 1 of the inventive concept is observed. On the SEM image, the positive electrode active material particles PAM exhibit a relatively large particle shape, and the conductive material CA exhibits a shape uniformly distributed on the particle surface.

Referring to FIGS. 5A and 5B, a structure in which the density of the conductive material CA distributed on the surface of the positive electrode active material particles PAM increased, as the weight ratio of the conductive material CA on the surface of the positive electrode active material particles PAM according to Example 2 of the inventive concept increased from 100:0.1 to 100:0.2 is observed. Accordingly, it is seen that the conductive material CA exhibits a more densely formed coating layer.

Referring to FIGS. 6A and 6B, a structure in which the entire surface of the positive electrode active material particles PAM is more thickly and continuously covered with the conductive material CA, as the weight ratio of the conductive material CA increases to 100:0.3 is observed.

FIG. 7 shows SEM analysis results for an electrode for an all-solid-state battery according to Example 1 of the inventive concept. FIG. 8 shows SEM analysis results for an electrode for an all-solid-state battery according to Comparative Example 1 of the inventive concept.

Specifically, referring to FIG. 7, a structure in which the positive electrode active material particles PAM (LiCoO₂) are formed with the conductive material CA (carbon nanotubes, CNT) uniformly applied onto the surface thereof, and the conductive material CA (carbon nanotubes, CNT) is selectively distributed only on the surface of the positive electrode active material particles PAM LiCoO₂) without penetrating into the solid electrolyte particles SE (Li₃InCl₆) is observed.

Referring to FIG. 8, the positive electrode active material particles PAM (LiCoO₂), the solid electrolyte particles SE (Li₃InCl₆), and the conductive material CA (carbon black) are formed in a mixed state. The conductive material CA (carbon black) is not selectively distributed on the surface of the positive electrode active material particles PAM (LiCoO₂), but is instead randomly mixed with the solid electrolyte particles SE (i₃InCl₆).

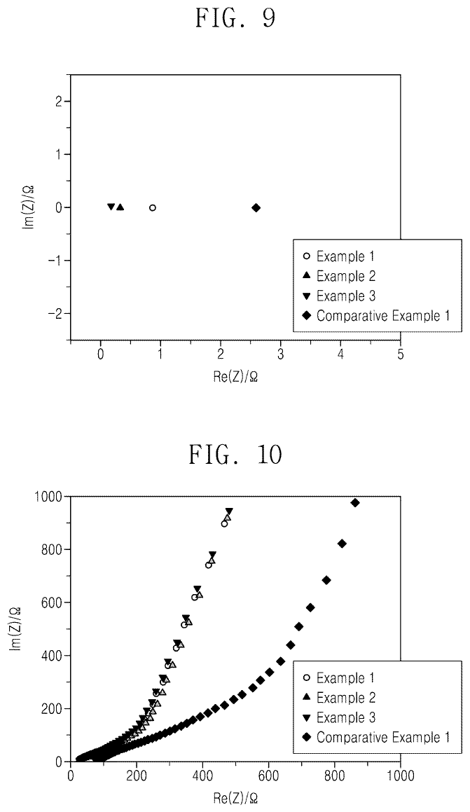

FIG. 9 shows electronic conductivity EIS measurement results for electrodes for an all-solid-state battery according to Example 1, Example 2, Example 3, and Comparative Example 1 of the inventive concept.

Referring to FIG. 9, it is seen that Examples 1, 2, and 3, in which the conductive material CA is applied onto the surface of positive electrode active material particles PAM, exhibit lower impedance and superior electronic conductivity within the electrode compared to Comparative Example 1, in which the conductive material CA is simply mixed with the positive electrode active material particles PAM and the solid electrolyte.

Conversely, Comparative Example 1 exhibited the highest impedance despite containing 2 wt % of the conductive material CA randomly mixed with the positive electrode active material particles PAM and the solid electrolyte particles SE. This demonstrates that by selectively applying the conductive material CA onto the surface of the positive electrode active material particles PAM, an effective electron conduction pathway may be secured even with a small amount of the conductive material CA along with excellent electronic conductivity.

FIG. 10 shows ionic conductivity EIS measurement results for electrodes according to Example 1, Example 2, Example 3, and Comparative Example 1 of the inventive concept.

Referring to FIG. 10, it is seen that Examples 1, 2, and 3 exhibit superior ionic conductivity by exhibiting lower impedance than Comparative Example 1. Conversely, it is seen that Comparative Example 1 exhibits the highest impedance and poor ionic conductivity. This demonstrates that the electrode of the inventive concept has excellent ionic conductivity by selectively applying the conductive material CA onto the surface of positive electrode active material particles PAM, thereby securing a stable ion conduction pathway without interfering with an ion transfer pathway within the solid electrolyte particles SE.

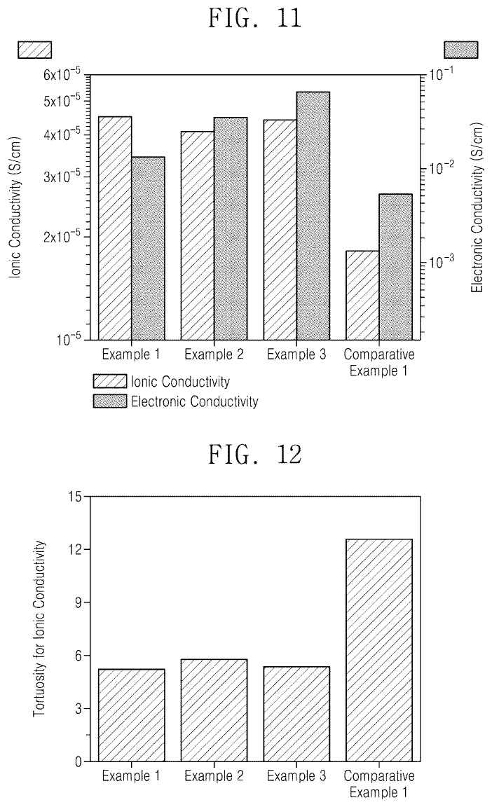

FIG. 11 shows electronic conductivity and ionic conductivity analysis results for electrodes according to Example 1, Example 2, Example 3, and Comparative Example 1 of the inventive concept.

Referring to FIG. 11, it is seen that Examples 1, 2, and 3 exhibit higher values for both electronic and ionic conductivities than Comparative Example 1. Conversely, Comparative Example 1 exhibited the lowest values for both indicators. This demonstrates that the electrode of the inventive concept may separate and optimize the respective transfer pathways for electrons and ions by selectively applying the conductive material CA onto the surface of the positive electrode active material particles PAM, thereby improving both electronic conductivity and ionic conductivity even with a small amount of conductive material.

FIG. 12 shows tortuosity analysis results for an electrode for ionic conductivity of electrodes according to Example 1, Example 2, Example 3, and Comparative Example 1 of the inventive concept.

Referring to FIG. 12, it is seen that Examples 1, 2, and 3 all exhibit a tortuosity value of 6 or less, enabling an ion transfer pathway within the electrode to be efficient. Conversely, it is seen that Comparative Example 1 exhibits the highest tortuosity, which is 12 or greater, resulting in reduced efficiency of an ion transfer pathway within the electrode. This demonstrates that the electrode of the inventive concept may secure excellent ion conductivity by selectively applying the conductive material CA onto the surface of the positive electrode active material particles PAM, thereby maintaining low tortuosity without interfering with an ion transfer pathway within the solid electrolyte particles SE.

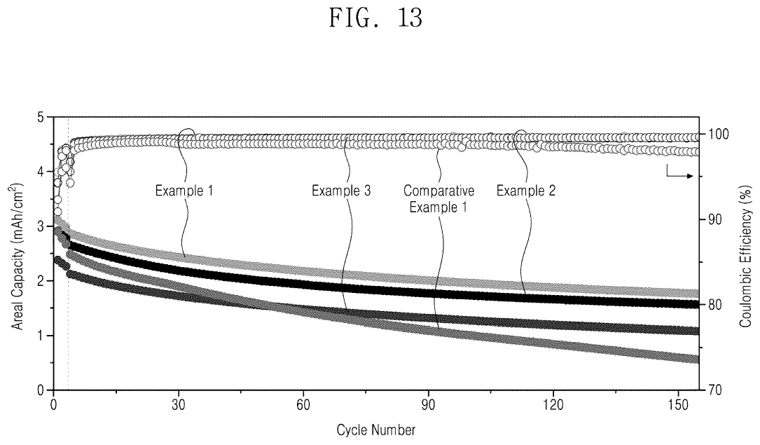

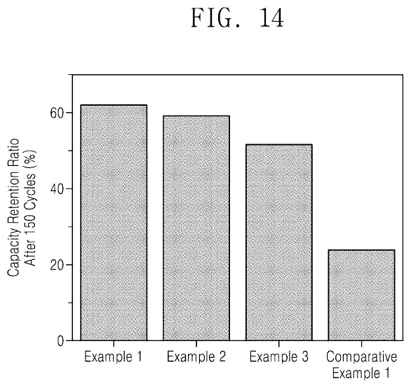

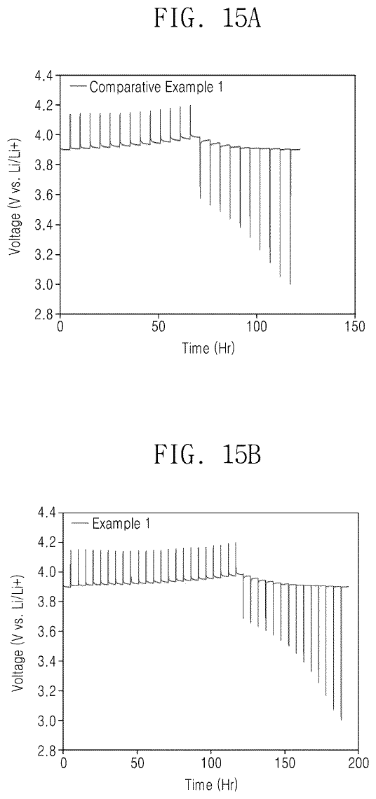

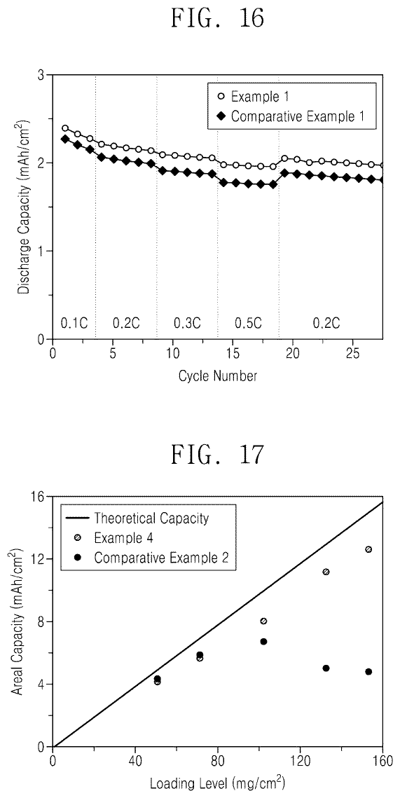

FIG. 13 shows charge/discharge characteristic analysis results for electrodes according to Example 1, Example 2, Example 3, and Comparative Example 1 of the inventive concept. FIG. 14 shows capacity retention comparison results for electrodes according to Example 1, Example 2, Example 3, and Comparative Example 1 of the inventive concept. FIGS. 15A and 15B show GITT analysis results for electrodes according to Example 1 and Comparative Example 1 of the inventive concept. FIG. 16 shows rate evaluation results for electrodes according to Example 1 and Comparative Example 1 of the inventive concept.

Referring to FIG. 13, the charge/discharge characteristics and coulombic efficiency of the electrodes according to Examples 1, 2, and 3, and Comparative Example 1 of the inventive concept are observed. Each electrode was evaluated for performance by repeating three cycles of charge/discharge at a 0.1 C-rate, followed by 150 cycles of charge/discharge at a 0.3 C-rate. Examples 1, 2, and 3 exhibited superior capacity retention characteristics compared to Comparative Example 1, and also maintained a stable value of about 99% or greater for the coulombic efficiency.

Referring to FIG. 14, the results of a quantitative comparison of capacity retention after 150 cycles of charge/discharge for the electrodes according to Examples 1, 2, and 3, and Comparative Example 1 of the inventive concept are observed. Examples 1, 2, and 3 each exhibited a capacity retention of about 60%, while Comparative Example 1 exhibited the lowest capacity retention, which is about 25%.

Referring to FIGS. 15A and 15B, the GITT analysis results performed on Example 1 of the inventive concept and Comparative Example 1 show that Example 1 secures an interfacial reaction area that is about 40% wider than that of Comparative Example 1, and thus, a lithium ion transfer pathway between the positive electrode active material and the solid electrolyte is more efficient.

Referring to FIG. 16, the results of evaluating the rate characteristics of Example 1 of the inventive concept and Comparative Example 1 are observed. The analysis of the charge/discharge characteristics step-by-step from 0.1 C to 0.5 C-rate shows that Example 1 exhibits superior capacity characteristics across all rates compared to Comparative Example 1. Accordingly, the electrode of the inventive concept may achieve high power and excellent rate characteristics by improving electronic and ionic conductivities.

Referring collectively to FIGS. 13 to 16, the electrode of the inventive concept may effectively secure an electron conduction pathway and an ion conduction pathway within the electrode by selectively applying the conductive material CA onto the surface of the positive electrode active material particles PAM, thereby improving electrochemical performance such as charge/discharge durability, interfacial reactivity, and high-rate charge/discharge characteristics.

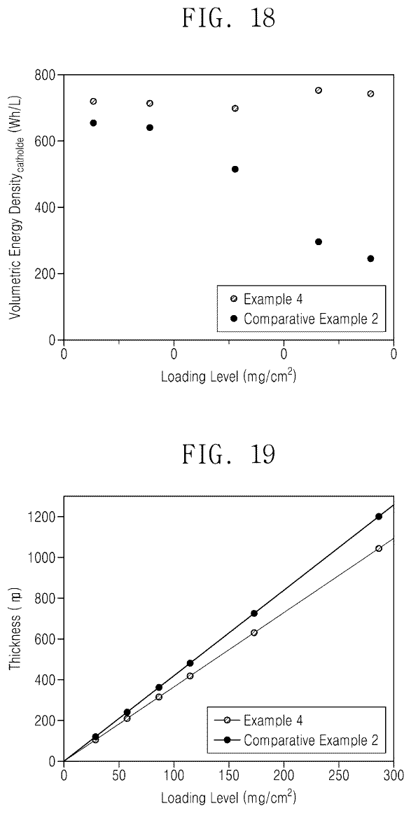

FIG. 17 shows achieved capacity evaluation results according to the loading amount of electrodes according to Example 4 and Comparative Example 2 of the inventive concept. FIG. 18 shows energy density per unit volume evaluation results according to the loading amount of electrodes according to Example 4 and Comparative Example 2 of the inventive concept. FIG. 19 shows electrode thickness evaluation results according to the loading amount of electrodes according to Example 4 and Comparative Example 2 of the inventive concept.

Specifically, referring to FIG. 17, it is seen that Example 4 achieves a discharge capacity close to theoretical capacity even as the loading amount increases. In particular, the discharge capacity remains similar to the theoretical capacity even under high-loading conditions of 153 mg/cm². Conversely, it is seen that Comparative Example 2 shows a gradually increasing difference from the theoretical capacity as the loading amount increases, and a remarkable capacity degradation under conditions of 120 mg/cm² or greater.

Referring to FIG. 18, it is seen that the energy density per volume of Example 4 is also greater than that of Comparative Example 2. It is seen that Example 4 maintains an energy density of about 700 Wh/L or greater throughout all loading ranges, while Comparative Example 2 exhibits a rapid decrease in energy density as the loading amount increases.

Referring to FIG. 19, packing density may be compared through changes in electrode thickness as the loading amount increases. It is seen that Example 4 exhibits a lower thickness increase than Comparative Example 2 under the same loading conditions, thereby securing a high packing density.

Referring collectively to FIGS. 17 to 19, it is seen that the electrode of the inventive concept may achieve an electrode having excellent discharge capacity, energy density, and packing density characteristics together even under high-loading conditions by selectively applying the conductive material CA onto the surface of the positive electrode active material particles PAM.

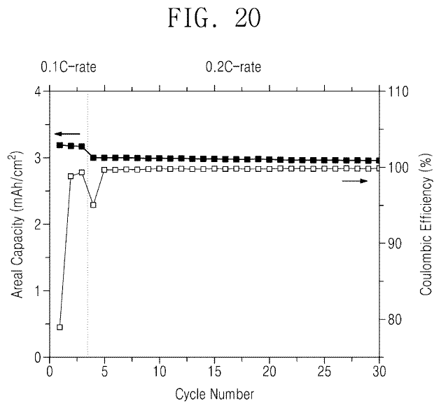

FIG. 20 is capacity retention analysis results for an electrode according to Example 5 of the inventive concept.

Referring to FIG. 20, it is seen that the electrode of Example 5, which applies a high-energy-density active material (NCM622) and a high-ionic conductivity solid electrolyte (LPSCl), and forms an interfacial stabilization protection layer (LiNbO₃), exhibits stable discharge capacity after the initial activation period. Specifically, following three cycles of charge/discharge at a 0.1 C-rate, the results evaluated at a 0.2 C-rate show that a discharge capacity per unit area of about 3.6 mAh/cm² was maintained, and a stable retention was achieved without capacity reduction over the subsequent 30 cycles of charge/discharge.

This demonstrates that the electrode design of the inventive concept may secure electronic conductivity, ionic conductivity, and interface stability even when applying a high-capacity active material, and achieve excellent capacity characteristics and charge/discharge stability.

An electrode for an all-solid-state battery according to an embodiment of the inventive concept and an all-solid-state battery including the same may include a conductive material applied onto active material particles and solid electrolyte particles mixed with the active material particles. By coating the active material with the conductive material, the conductive material may be spatially separated from the solid electrolyte, which allows the migration of electrons and the migration of lithium ions to proceed independently without mutual interference. Accordingly, the efficiency of electron conduction and ion conduction within the electrode may be enhanced, and the output characteristics, charge/discharge performance, and energy density of the all-solid-state battery may be improved.

Embodiments of the disclosure have been described with reference to the accompanying drawings. However, the disclosure may be implemented in other detailed forms without changing the technical spirit or necessary features thereof. It is therefore to be understood that the above-described embodiments are illustrative in all aspects and not restrictive.

What is claimed is:

1. An electrode for an all-solid-state battery, comprising:
a current collector; and
an active material layer on the current collector,
wherein the active material layer includes:
active material particles;
solid electrolyte particles mixed with the active material particles; and
a conductive material applied onto the active material particles,
wherein the conductive material has a diameter of about 1 to about 500 nm,
the conductive material has a length of about 1 to about 500 μm,
the conductive material has an aspect ratio of about 5 to about 50,000, and
the conductive material is present in an amount of about 0.01 to about 0.5 parts by weight with respect to 100 parts by weight of the active material particles.

2. The electrode for an all-solid-state battery of claim 1, wherein the conductive material comprises single-walled carbon nanotubes or multi-walled carbon nanotubes.

3. The electrode for an all-solid-state battery of claim 1, wherein the active material particles comprise at least one of LiNiₓCo_{y}Mn_{z}O₂ (x+y+z=1), LiMn₂O₄, or LiFePO₄.

4. The electrode for an all-solid-state battery of claim 1, wherein the active material particles comprise at least one of natural graphite, artificial graphite, amorphous carbon, silicon, silicon-carbon (Si—C) composite, silicon oxide (SiOₓ), aluminum, tin, or Li₄Ti₅O₁₂ (LTO).

5. The electrode for an all-solid-state battery of claim 1, wherein the solid electrolyte comprises at least one of Li₄₋ₓGe₁₋ₓPₓS₄ (LGPS), Li₃PS₄ glass-ceramic, Li₇P₃S₁₁ glass-ceramic (LPS), Li₄SnS₄, Li₆PS₅X (X=Cl, Br, I), Li₃ErX₆, Li₃GdX₆, Li₃YX₆, or Li₃InX₆ (X=Cl, Br, I).

6. The electrode for an all-solid-state battery of claim 1, wherein the conductive material is present in an amount of about 0.05 to about 0.2 parts by weight with respect to 100 parts by weight of the active material particles.

7. The electrode for an all-solid-state battery of claim 3, wherein the active material layer further comprises a positive electrode protection layer,
the positive electrode protection layer is applied onto the active material particles coated with the conductive material, and
the positive electrode protection layer comprises at least one of lithium niobate (LiNbO₃), lithium tantalate (LiTaO₃), lithium aluminum oxide (LiAlO₂), or lithium phosphate (Li₃PO₄).

8. The electrode for an all-solid-state battery of claim 1, wherein the active material particles in the electrode for an all-solid-state battery have a volume fraction of about 0.5 to about 0.99.

9. An all-solid-state battery comprising:
a first electrode;
a second electrode spaced apart from the first electrode; and
a solid electrolyte layer interposed between the first electrode and the second electrode,
wherein at least one of the first electrode or the second electrode includes:
a current collector; and
an active material layer on the current collector,
the active material layer including:
active material particles;
solid electrolyte particles mixed with the active material particles; and
a one-dimensional conductive material applied onto the active material particles,
wherein the conductive material is present in an amount of about 0.01 to about 0.5 parts by weight with respect to 100 parts by weight of the active material particles.

10. The all-solid-state battery of claim 9, wherein the one-dimensional conductive material comprises single-walled carbon nanotubes or multi-walled carbon nanotubes.

11. The all-solid-state battery of claim 9, wherein the active material particles have a size of about 300 nm to about 100 μm.

12. The all-solid-state battery of claim 9, wherein the conductive material is present in an amount of about 0.05 to about 0.2 parts by weight with respect to 100 parts by weight of the active material particles.

13. The all-solid-state battery of claim 9, wherein the solid electrolyte particles of the first electrode or the second electrode have a volume fraction of about 0.01 to about 0.5.

14. The all-solid-state battery of claim 10, wherein the active material layer further comprises a binder.

15. An all-solid-state battery comprising:
a positive electrode;
a negative electrode spaced apart from the positive electrode; and
a solid electrolyte layer interposed between the positive electrode and the negative electrode,
wherein the positive electrode includes:
a positive electrode current collector; and
a positive electrode active material layer on the positive electrode current collector,
the positive electrode active material layer including a first portion and a second portion,
wherein in the first portion, solid electrolyte particles are disposed, and
in the second portion, positive electrode active material particles and a conductive material are disposed.

16. The all-solid-state battery of claim 15, wherein the positive electrode has an areal capacity of about 3 to about 15 mAh/cm².

17. The all-solid-state battery of claim 15, wherein the conductive material comprises single-walled carbon nanotubes or multi-walled carbon nanotubes.

18. The all-solid-state battery of claim 15, wherein the positive electrode has a tortuosity of about 1.5 to about 8.

19. The all-solid-state battery of claim 15, wherein the conductive material is not positioned in the first portion.

20. The all-solid-state battery of claim 15, wherein the conductive material is present in an amount of about 0.01 to about 0.5 parts by weight with respect to 100 parts by weight of the positive electrode active material particles.
